(19) United States
(12) Patent Application Publication
(10) Pub. No.: US 2026/0267710 A1
(43) Pub. Date: Sep. 10, 2026

(54) WEARABLE ELECTRONIC DEVICE AND DYNAMIC RESOURCE CONFIGURATION METHOD BASED ON AMBIENT-ADAPTIVE AND CONTEXT-AWARE INFORMATION

(71) Applicant: MEDIATEK INC., Hsinchu City (TW)

(72) Inventors: Hsieh-Chang Ho, Hsinchu City (TW); Chi-Cheng Ju, Hsinchu City (TW); Ying-Jui Chen, Hsinchu City (TW); Hao-Yu You, Hsinchu City (TW); Sheng-Chih Huang, Hsinchu City (TW); Yu-Ming Lin, Hsinchu City (TW)

(73) Assignee: MEDIATEK INC., Hsinchu City (TW)

(21) Appl. No.: 19/557,144

(22) Filed: Mar. 5, 2026

Related U.S. Application Data
(60) Provisional application No. 63/768,260, filed on Mar. 7, 2025.

(51) Int. Cl. G06F 9/50; G06F 11/30

(52) U.S. Cl. CPC G06F 9/5083; G06F 11/3058; G06F 2209/503

(57) ABSTRACT

A dynamic resource configuration method of a wearable electronic device includes: obtaining sensed information from at least one sensor of the wearable electronic device and collecting device information from the wearable electronic device; generating contextual information according to at least one of the sensed information, the collected device information, and a user selection signal; and, determining a resource allocation scenario for dynamically configuring hardware resources of the wearable electronic device according to the contextual information.

### CROSS REFERENCE TO RELATED APPLICATIONS

This application claims the benefit of U.S. Provisional Application No. 63/768,260, filed on March 7th, 2025. The content of the application is incorporated herein by reference.

### BACKGROUND

The invention relates to a wearable electronic device, and more particularly to a wearable electronic device with dynamic resource configuration capabilities.

Generally speaking, with the rapid advancement of mobile technology, the modern wearable devices, e.g. smart glasses, Augmented Reality (AR) glasses, Virtual Reality (VR) headsets, and smart watches, are increasingly integrated with complex features and functionalities compared to traditional devices. However, the integration of these advanced functionalities presents a challenge regarding power consumption. The wearable devices often suffer from high power consumption issues during daily use. These wearable devices often fail to meet the needs for long-term usage or all-day operation without frequent recharging.

### SUMMARY

Therefore, one of the objectives of the present invention is to provide a wearable electronic device and a dynamic resource configuration method, to solve the above-mentioned problems.

The dynamic resource configuration method can balance power consumption, end-to-end latency, and output quality to extend the operation time of the wearable electronic device. In addition, the dynamic resource configuration method is used for dynamically configuring resources based on conditions such as usage scenarios, workloads, external environments, … etc., to achieve the performance targets in power/latency/quality.

According to embodiments of the present invention, a dynamic resource configuration method of a wearable electronic device is disclosed. The method comprises: obtaining sensed information from at least one sensor of the wearable electronic device and collecting device information from the wearable electronic device; generating contextual information according to at least one of the sensed information, the collected device information, and a user selection signal; and, determining a resource allocation scenario for dynamically configuring hardware resources of the wearable electronic device according to the contextual information.

According to the embodiments, a wearable electronic device is disclosed. The wearable electronic device comprises at least one sensor, a memory circuit, and a processing unit. The at least one sensor is used for providing sensed information. The processing unit is coupled to the memory circuit and the at least one sensor. The processing unit further comprises an ambient-adaptive sub-unit and a context-aware sub-unit. The ambient-adaptive sub-unit is used for obtaining the sensed information and collecting device information from the wearable electronic device. The context-aware sub-unit is used for generating contextual information according to at least one of the sensed information, the collected device information, and a user selection signal, and for determining a resource allocation scenario for dynamically configuring hardware resources of the wearable electronic device according to the contextual information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the software and hardware architecture of a wearable electronic device according to an embodiment of the present invention.

FIG. 2 is a block diagram illustrating a hardware architecture of the electronic device as shown in FIG. 1 according to an exemplary embodiment of the present invention.

FIG. 3 is a diagram illustrating a hardware architecture of the ISP (image signal processor) as shown in FIG. 2 according to an exemplary embodiment of the present invention.

FIG. 4 is a diagram illustrating a dynamic resource configuration system of wearable electronic device of FIG. 1 according to an embodiment of the present invention.

FIG. 5 is a diagram showing an example of switching the wearable electronic device to be a master device or a slave device according to an embodiment of the present invention.

FIG. 6A is a diagram of an example of the distributed processing scenario according to an embodiment of the present invention.

FIG. 6B is a diagram of an example of the distributed processing scenario according to an embodiment of the present invention.

FIG. 6C is a diagram of an example of the distributed processing scenario according to an embodiment of the present invention.

FIG. 7 is a diagram of an example of the scalable processing scenario according to an embodiment of the present invention.

FIG. 8 is a diagram of an example of the scalable processing scenario for the module-configuration according to a different embodiment of the present invention.

FIG. 9 is a diagram of an example of the dynamic OS adjustment scenario according to a different embodiment of the present invention.

FIG. 10 is a diagram of an example of the dynamic processing resources adjustment scenario according to an embodiment of the present invention.

FIG. 11 is a diagram illustrating a method of the dynamic resource configuration operations for operating the wearable electronic device as shown in FIG. 1 according to an embodiment of the invention.

### DETAILED DESCRIPTION

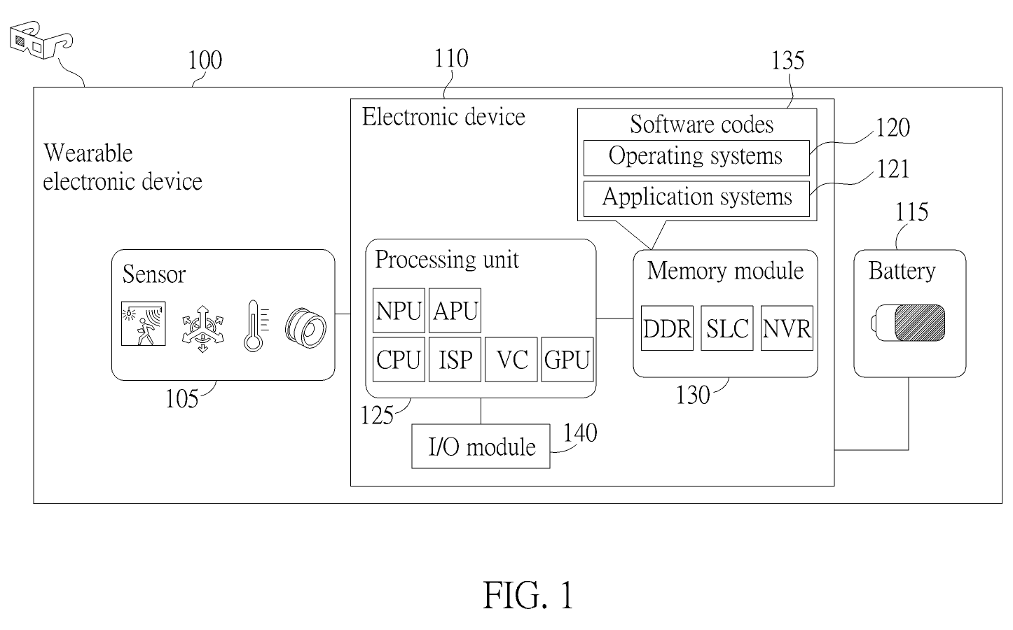

FIG. 1 is a schematic diagram illustrating the software and hardware architecture of a wearable electronic device 100 according to an embodiment of the present invention. The wearable electronic device 100 may be implemented as (but not limited) a smart glass device, an AR (Augmented Reality) glass device, a VR (Virtual Reality) headset, or a smart watch device, and can integrate computing information, data processing, and communication functions into the wearable electronic device 100.

The wearable electronic device 100 includes one or more sensors 105, an electronic device 110 such as an integrated circuit or circuit module, and a battery 115. The sensor(s) 105 may be fixed connecting with the electronic device 110 together within the wearable electronic device 100, or the sensor(s) 105 may be detachable from the wearable electronic device 100 and connecting with the electronic device 110 through an interface. The electronic device 110 includes one or more processing units 125, one or more memory modules 130, and at least one I/O module 140 for receiving user’s control request.

The sensors 105 for example comprise (but not limited) image sensor(s) such as CMOS/CCD sensors, light/optical sensor(s), temperature sensor(s), accelerometer(s), gyroscopes, light intensity sensor(s), motion sensor(s), IMU (Inertial Measurement Unit), PPG (Photoplethysmography) sensor(s), microphones, air pressure sensor, humidity sensor, camera module(s), and/or other environmental sensor(s).

The processing units 125 may include CPU(s) (central processing unit), graphics processing unit(s) (GPU), NPU (Neural Processing Unit, APU (Accelerated Processing Unit, video codec (VC), and/or image signal processor(s) (ISP).

The memory modules 130 for example include DRAM (Dynamic Random Access Memory) module, Non-Volatile Random-Access Memory (NVRAM) and high-performance cache memory such as SLC (System Level Cache) that is used to accelerate data access. The memory modules 130 store a plurality of software codes 135 to be fetched and executed by the processing units 125. The software codes 135 include operating systems 120 and application programs 121. The operating systems 120 may at least include a light-weight OS (e.g. FreeRTOS or Zephyr) and a heavy-weight OS (e.g. Android or Linux).

The battery 115 includes a battery management system (BMS) and one or more battery cells which convert chemical energy into electricity to power the wearable electronic device 100.

The above-mentioned hardware modules/units/circuits can also be collectively referred to as perception hardware units for the resource configurations of wearable electronic device 100.

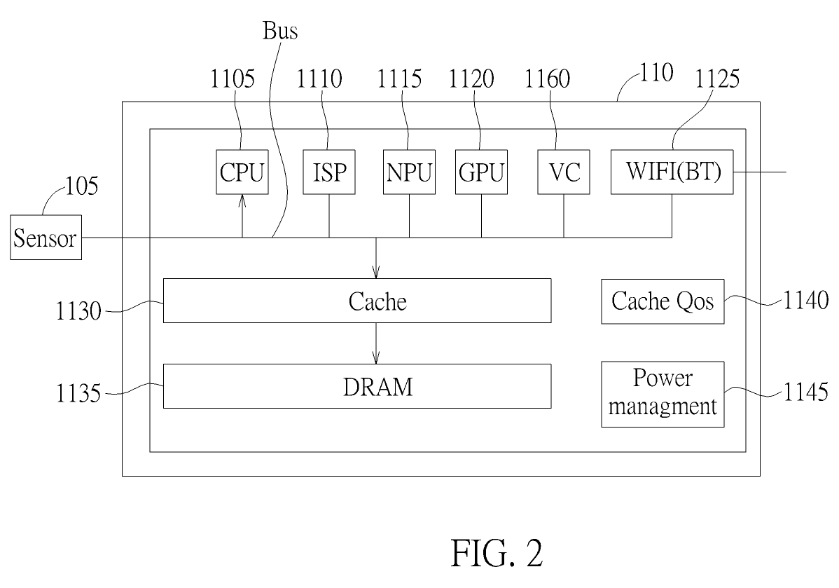

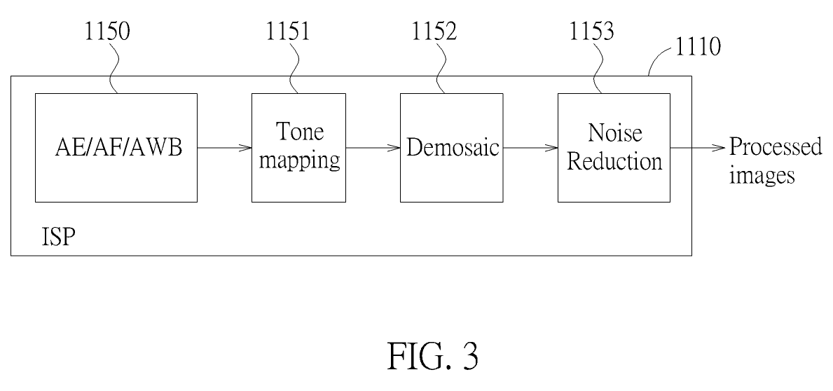

Refer to FIGS. 2 and 3. FIG. 2 is a block diagram illustrating a hardware architecture of the electronic device 110 as shown in FIG. 1 according to an exemplary embodiment of the present invention. FIG. 3 is a diagram illustrating a hardware architecture of the ISP (image signal processor) 1110 as shown in FIG. 2 according to an exemplary embodiment of the present invention. In the embodiment, the electronic device 110 is for example applied into a smart glass device (e.g., augmented reality glasses or a head-mounted display) configured to process environmental data and display visual information for a user. In FIG. 2, the electronic device 110 for example is coupled with at least one sensor 105 such as an image sensor and is coupled with a remote mobile device (not shown in FIG. 2) through a wireless communication module 1125. The electronic device 110 is, for example, implemented as a System-on-Chip (SoC) or a system-in-package (SiP) that integrates various processing units, memory circuits, and communication modules to optimize power consumption. In one embodiment, the image sensor 105 may be included within the electronic device 110.

The electronic device 110 includes a plurality of processing units/engines such as CPU 1105, an ISP (Image Signal Processor) 1110, a NPU (Neural Processing Unit) 1115, and GPU (Graphics Processing Unit) 1120, a wireless communication module 1125 (e.g. Wi-Fi module or Bluetooth (BT) module), a cache 1130 such as SLC cache, a DRAM module 1135, a Video codec module (VC) 1160, and a bus coupled to the modules mentioned above. The electronic device 110 further includes a cache Quality of Service (QoS) module 1140 and a power management module 1145. As shown in FIG. 3, the ISP 1110 includes a 3A control module 1150 with AF/AE/AWB (auto focus/auto exposure/auto white balance) function, a tone mapping module 1151, a demosaic module 1152, and a noise reduction (NR) module 1153. The 3A control module 1150 is used to perform an AE(auto exposure), AF (auto focus), and/or AWB (auto white balance) operations upon the sensed images. The tone mapping module 1151 is used to convert a real-world high dynamic range (HDR) data captured by the sensor 105 such as an image sensor into a standard dynamic range (SDR) format that can be properly displayed with limited brightness and contrast capabilities. The demosaic module 1152 is used to perform a color interpolation to convert the incomplete/raw color image captured by the image sensor into a full-color image. The noise reduction (NR) module 1153 is used to determine noise level and to filter out noise from image pixels.

The CPU 1105 is used as a main controller of the wearable electronic device 110, and is configured to execute a selected operating system (OS) 120 and application programs 121, manage hardware resources, and coordinate/configure the operations of other components/modules of the electronic device 110. For instance, the CPU 1105 may initiate a camera application and instruct the ISP 1110 to process image data received from the sensor 105. The sensor 105 for example is an image sensor which is used to capture raw optical data and to output image signals such as RGB raw data.

The ISP 1110 is coupled to the sensor 105 (when implemented as a camera or image sensor) to receive raw image data (e.g. RGB raw data), and is configured to perform image processing operations such as demosaicing (color interpolation), noise reduction (NR), auto exposure (AE), auto focus (AF), auto white balance (AWB), and/or a pixel correction to generate and output a processed image signal (e.g. YUV data). The processed image signal can be high-quality digital images (or video) streams.

The NPU 1115 is a hardware accelerator which is configured for performing machine learning and artificial intelligence tasks. In this embodiment, the NPU 1115 receives the processed image data from the ISP 1110 to perform computer vision tasks which may include object recognition (e.g. identifying a landmark the user is looking at), face detection, hand gesture recognition for the user interface control, or simultaneous localization and mapping (SLAM) calculations.

The GPU 1120 (e.g. display engine) is configured to render graphics content, and for example generates an AR overlay or a user interface (UI) to be displayed on a display unit (not shown in FIG. 1) of the wearable electronic device 100. That is, the GPU 1120 is used to prepare the data for display to overlay text (e.g. timestamps, teletext, subtitle, closed caption) onto the images of the image signal before the images are displayed. For example, if the NPU 1115 identifies a restaurant, the GPU 1120 renders a virtual navigation arrow or a rating bubble overlaid on the user's real-world view.

The cache 1130 is used as a high-speed shared memory (e.g. system level cache) accessible by the CPU 1105, ISP 1110, NPU 1115, and GPU 1120. The DRAM module 1135 is controlled by a DRAM controller (not shown in FIG. 2) and is used as the main system memory for storing larger data sets, application codes, control instructions, and OS information/data.

The cache QoS module 1140 is used to manage the allocation and priority of the cache 1130. Since the multiple processing cores (CPU 1105, ISP 1110, NPU 1115, or GPU 1120) may compete for cache’s 1130 shared resources, the cache QoS module 1140 is configured to dynamically adjust bandwidths or cache partition sizes based on the urgencies of the tasks. For example, to avoid frame drops, the cache QoS module 1140 may prioritize memory requests from the ISP 1110 and GPU 1120 over the background tasks running on the CPU 1105.

The wireless communication module 1125 is used to support wireless communication standards such as Wi-Fi or Bluetooth, and is configured to establish a wireless connection with a remote electronic device, so that the wireless connection can enable offloading of heavy computational tasks to the remote electronic device or receiving notifications (e.g., messages, calls) to be displayed on the wearable electronic device 100 such as a smart glass device when the wearable electronic device 100 pairs with the remote electronic device. The remote electronic device can be a mobile device, a smartphone, tablet, a laptop, a personal computer, or a cloud server.

The power management module 1145 is used to manage power distribution within the wearable electronic device 110. The power management module 1145 can monitor the battery level of battery 115 to dynamically adjust the power consumption of the CPU 1105, ISP 1110, GPU 1120, and NPU 1115 to extend battery life or save power in response to different scenarios.

The VC 1160 is used for compressing/decompressing image data or encoding/decoding a video signal.

For example, in an operation, when a user activates an AR navigation operation/function, the sensor 105 captures the images of street view, the ISP 1110 processes the visual images, the NPU 1115 analyzes the scene of visual images to determine a location, the CPU 1105 retrieves the navigation data via the wireless communication module 1125, and the GPU 1120 renders directional arrows on the visual images. The cache QoS module 1140 ensures that the data flows pass through the cache 1130 and DRAM module 1135 with a low latency to provide a smooth user experience.

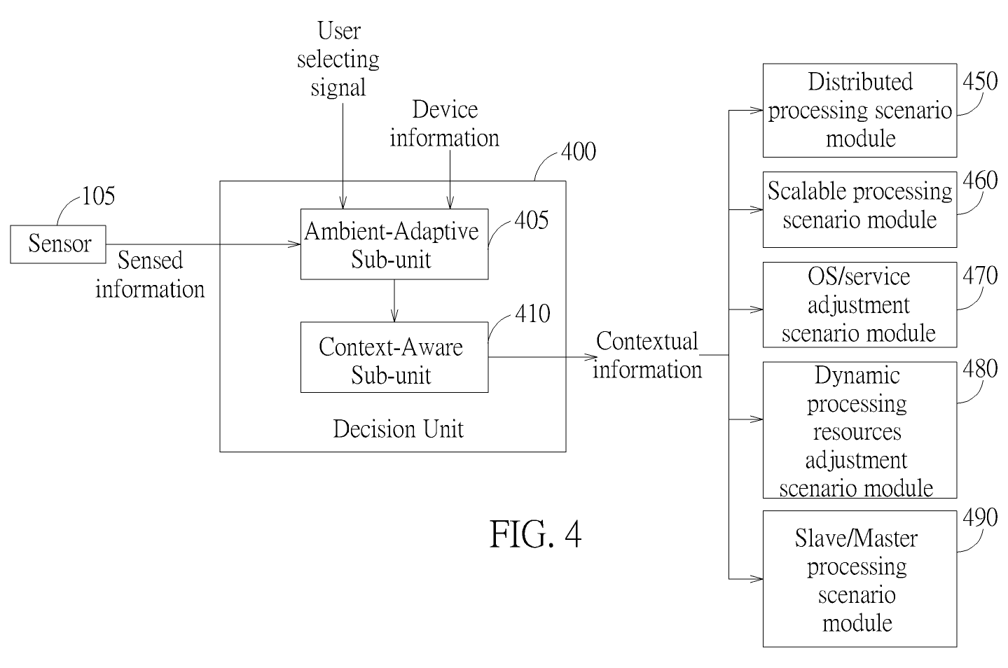

Refer to FIG. 4. FIG. 4 is a diagram illustrating a dynamic resource configuration system of wearable electronic device 100 of FIG. 1 according to an embodiment of the present invention. As shown in FIG. 4, the system may be implemented within the electronic device 110 to optimize performance and power consumption.

The dynamic resource configuration system includes a decision unit 400, a distributed processing scenario module 450, a scalable processing scenario module 460, a dynamic operating system (OS)/service adjustment scenario module 470, a dynamic processing resources adjustment scenario module 480, and/or a slave/master processing scenario module 490. The decision unit 400 further includes an ambient-adaptive sub-unit 405 and a context-aware sub-unit 410. The distributed processing scenario module 450, the scalable processing scenario module 460, the dynamic operating system (OS)/service adjustment scenario module 470, the dynamic processing resources adjustment scenario module 480, the slave/master processing scenario module 490, the ambient-adaptive sub-unit 405 and the context-aware sub-unit 410 each can be implemented as a purely hardware circuit/module of the electronic device 110, a purely software module executed through the processing units/engines (e.g. the CPU 1105, ISP 1110, NPU 1115, GPU 1120, or VC 1160) of the electronic device 110, or a hybrid hardware/software module of the electronic device 110.

The one or more sensors 105 can be controlled by the CPU 1105 and are used for providing sensed information, and the sensed information is transmitted to the decision unit 400. For example, the sensed information includes a light intensity, an ambient temperature, or a user movement status. That is, the sensors 105 can collect the environmental information. In addition, in one embodiment, the sensed information can be sensed raw data or processed sensed data. For example, the sensed raw data may be sensed raw ambient light intensity, sensed raw temperature, or sensed image raw data (but not limited). Yet, in another embodiment, the sensed information can be the processed sensed data, e.g. the compressed image data, detected object information, or detected object motion vector information (but not limited).

In one embodiment, the sensed information may further include a user’s physiological data which includes parameters of real-time physical measurements that are generated by sensors and/or cameras. The user’s physiological data for example (but not limited) includes the user’s heart rate (HR) and heart rate variability (HRV), blood pressure, body temperature, respiration rate, pupil diameter (or dilation), blink rate and blink duration, galvanic skin response (GSR), and/or skin conductivity (often used to detect stress).

In one embodiment, the sensed information may further include the user’s ocular and visual data which includes the gaze direction/point of regard (where the user is looking), saccadic movement (rapid eye movement), inter-pupillary distance (IPD), and/or eye openness (used for detecting drowsiness).

The ambient-adaptive sub-unit 405 obtains the sensed information from the sensor 105 and collects device information from the wearable electronic device 100, and then it transmits the sensed information and the device information to the context-aware sub-unit 410. In one embodiment, the ambient-adaptive sub-unit 405 controls/queries/fetches/polls each hardware module to collect device information such as a battery status of the battery 115, a charge/discharge status of the battery 115, a battery life of the battery 115, a history log of the module, a processing power of the module, a device temperature profile, a processor utilization(e.g., CPU/GPU/ISP utilization), an available memory capacity, a cache occupancy, a memory bandwidth, and/or an available resource. In one embodiment, the ambient-adaptive sub-unit 405 can control the power management module 1145 to collect the battery status, charge/discharge status, battery life from the battery 115. In addition, the ambient-adaptive sub-unit 405 may be able to process the sensed raw data to generate the processed sensed data and transmit the processed sensed data to the context-aware sub-unit 410.In yet another embodiment, the ambient-adaptive sub-unit 405 can receive a user selection signal through the I/O module 140 once a user input certain request, and then it passes the user selection signal to the context-aware sub-unit 410.

The context-aware sub-unit 410 receives the sensed information (raw/processed sensed data), the collected device information, and/or the user selection signal to generate a contextual information according to the sensed information, the collected device information, and/or the user selection signal. For example, the context-aware sub-unit 410 can interpret the sensed information, the collected device information, and/or the user selection signal to generate and synthesize the contextual information which includes at least one of user information, a presence of a face or an object, user emotional information, image content information, image background information, environment information, and a user social context information. For example (but not limited), the user emotional information is for example the cognitive and mental state which may be the user’s emotion state, fatigue level or drowsiness, stress level or anxiety, attention level or focus intensity, cognitive load, and/or mood, and can be for example detected or derived from voice tone, raw biometric data, or facial muscle tension). The user information may include physical information, and/or behavior and contextual data. The physical information for example includes the user’s profile data, age, gender, height, weight, head size, head shape dimensions, vision prescription, facial feature, and/or face embedding. The behavior and contextual data for example includes the user’s posture (head tilt, spine alignment), gait (walking pattern), voice print or tonal qualities, activity status (e.g. sitting, walking, running, driving, meeting), and/or gesture history. The image content information is a background information or detected object information obtained from analyzing the user or people, or objects captured by cameras. The environmental information for example is location, weather, light intensity, or noise level. The user social context information may include the information of the number of people nearby, the social interactions, or information of proximity to others.

The context-aware sub-unit 410 then transmits the generated contextual information to one or more scenario modules (450 - 490). In one embodiment, the scenario modules (450 - 490) may be arranged to utilize AI (artificial intelligence) or other different algorithms to determine one or more resource allocation scenarios based on the generated contextual information and dynamically adjust or configure the hardware resources of hardware modules of the wearable electronic device 100 to optimize the power consumption of the system, balance power consumption, and provide end-to-end latency and output quality.

For example, to facilitate the sensor 105, ISP 1110, NPU 1115, GPU 1120, VC 1160 and/or other hardware modules, the scenario modules (450 - 490) are used to configure parameters/configurations for the sensor 105, ISP 1110, NPU 1115, GPU 1120, VC 1160, and/or other hardware modules based on a determined resource allocation scenario. The VC 1160, for example, is a video encoder to compress the processed image signal sent from an image sensor into different video encoding formats such as MPEG-4, HEVC, or VP9 for storage or transmission.

In the embodiments, for example (but not limited), the distributed processing scenario module 450 determines a distributed processing scenario, the scalable processing scenario module 460 determines a scalable processing scenario, the dynamic operating system (OS)/service adjustment scenario module 470 determines a dynamic operating system (OS) adjustment scenario, the dynamic processing resources adjustment scenario module 480 determines a dynamic processing resources adjustment scenario, and the slave/master processing scenario module 490 determines a slave/master processing scenario. The scenario modules (450 - 490) determine the scenarios independently. Alternatively, in another embodiment, these scenario modules (450 - 490) can operate in coordination or work in concert to determine the scenarios.

In one embodiment, the dynamic resource configuration is performed in a closed-loop manner. However, the present invention is not limited thereto; in other embodiments, the dynamic resource configuration may be performed in an open-loop manner, a semi-closed-loop manner, or a hybrid manner. In an example of the closed-loop manner, the decision unit 400 is configured to continuously obtain the device information indicating a performance status of the hardware modules of the wearable electronic device 100 after applying a specific resource allocation scenario. The decision unit 400 (or context-aware sub-unit 410) then updates the contextual information to update the resource allocation scenario accordingly to ensure the system stability. The performance status may include at least one of power consumption, latency, temperature (e.g., SoC temperature), and a quality indicator (e.g., image quality score or FPS).

In one embodiment, the decision unit 400 is configured to perform a multi-objective optimization process to achieve a concurrent balance, a joint optimization, or a dynamic coordination among power consumption, latency, and output quality. The scenario modules (450 - 490) determine the resource allocation scenarios by weighting the power consumption, the latency, and the output quality according to the contextual information. For instance, in a high-speed motion scenario (e.g., sports), the scenario modules (450 - 490) prioritize the low latency over the image quality and power consumption to ensure real-time tracking. In a scenic photography scenario, the scenario modules (450 - 490) prioritize the output quality over the latency and power consumption. In a standby scenario, the power consumption is minimized while maintaining a basic quality. By dynamically weighing these three factors—power, latency, and quality—according to the generated contextual information, the wearable electronic device 100 achieves an optimal user experience that adapts to the immediate needs of the environment and user behavior.

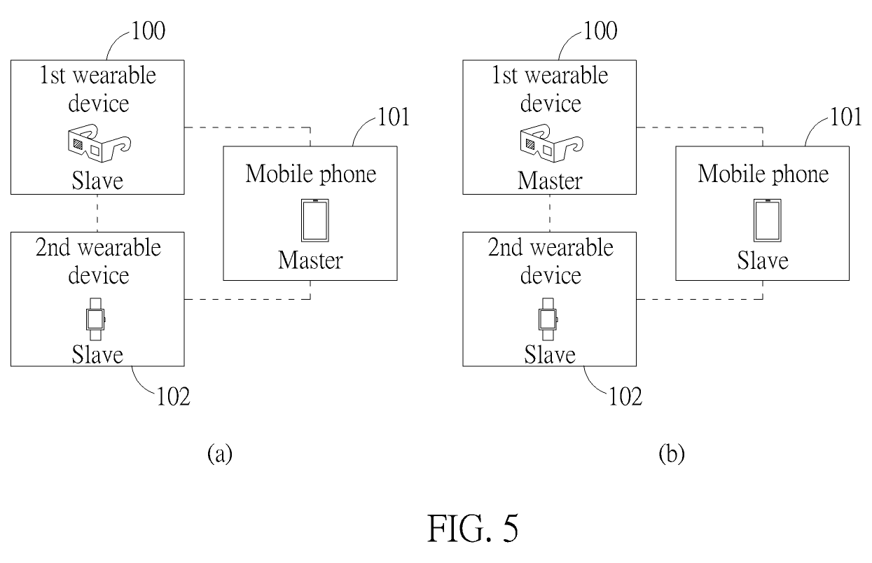

In one embodiment, the slave/master processing scenario, according to the contextual information, is determined by the slave/master processing scenario module 490 for dynamically switching the wearable electronic device 100 to be a master device or a slave device and for switching a remote electronic device to be a slave device or a master device accordingly. FIG. 5 is a diagram showing an example of switching the wearable electronic device 100 to be a master device or a slave device according to an embodiment of the present invention. The wearable electronic device 100, e.g. a smart glass device, is paired with and wirelessly connected to a remote electronic device such as the mobile phone 101 and/or the second wearable device 102 such as a smart watch device. In the slave/master processing scenario, the wearable electronic device 100 is to be switched to act as the slave device to save power and a remote electronic device such as the mobile phone 101 is switched to act as the master device if the contextual information indicates that the battery/power level (i.e. the device information) of wearable electronic device 100 is low, as shown in the portion (a) of FIG. 5. In this situation, the second wearable device 102 is used as another slave device. Alternatively, the wearable electronic device 100 is to be switched to act as the master device to improve performance and a remote electronic device such as the mobile phone 101 is switched to act as the slave device if the contextual information indicates that the battery/power level (i.e. the device information) of wearable electronic device 100 is not low, as shown in the portion (b) of FIG. 5. In such situation, the second wearable device 102 is used as another slave device.

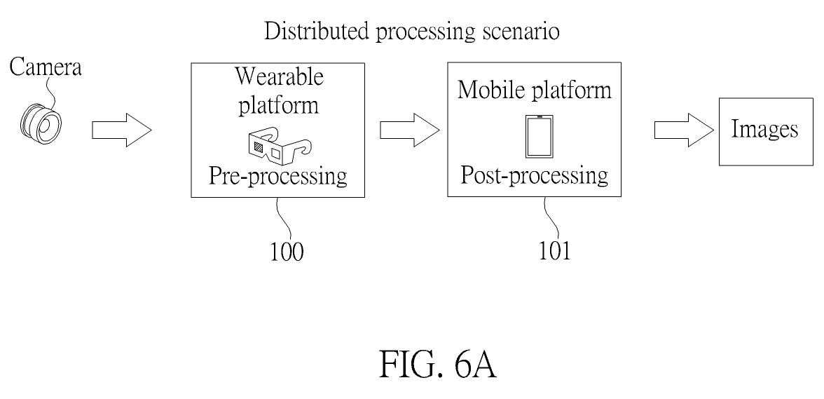

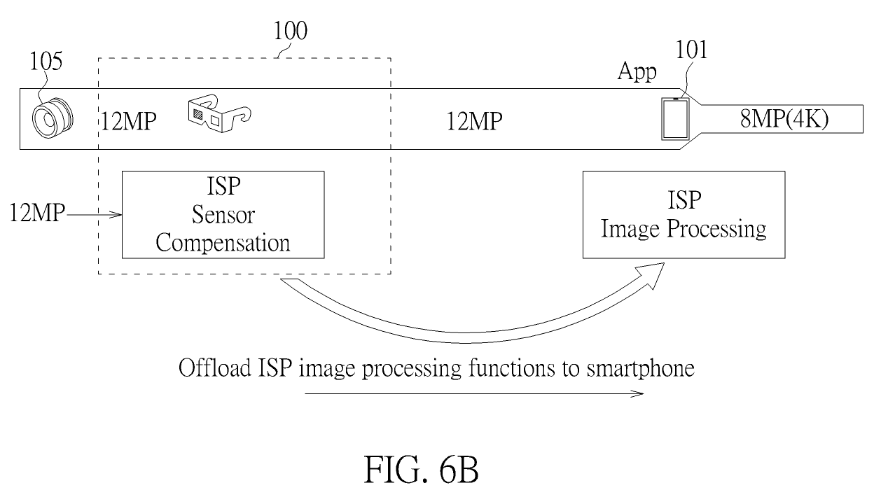

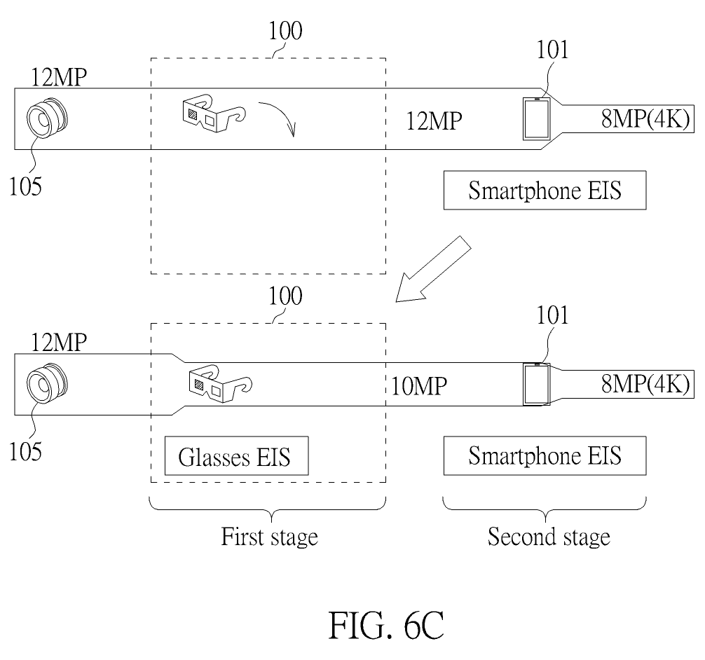

FIG. 6A is a diagram of an example of the distributed processing scenario according to an embodiment of the present invention. The distributed processing scenario module 450, according to the contextual information, is used for distributing operation tasks between the electronic device 110 and a remote electronic device such as a mobile phone 101. As shown in FIG. 6A, the camera (i.e. the sensor 105) is used to capture raw images and transmits the raw images to the electronic device 110. For example, the context-aware sub-unit 410 determines the contextual information based on sensed information and at least one collected device information such as the battery status, workload, or transmission latency. The distributed processing scenario is determined by the distributed processing scenario module 450 to dynamically distribute the operation tasks between the wearable electronic device 100 and the remote electronic device (mobile phone 101) according to the contextual information. In the distributed processing scenario, for example, the generated contextual information may indicate to reduce the power consumption of the wearable electronic device 100 (e.g. a smart glass device having a smaller battery may need to execute complex operation tasks), and the distributed processing scenario module 450 can configure the hardware modules of wearable electronic device 100 to distribute (or leave) complex processing tasks (or a larger portion of operation tasks or context-aware computing tasks) to be performed by the remote electronic device such as the mobile phone 101. In such circumstance, the mobile phone 101 completes the most complex processing tasks and then output the processing result (such as images). In one embodiment, the wearable electronic device 100 receives the computation result (such as images) of the operation tasks executed and completed by the remote electronic device. That is, the wearable electronic device 100 performs a pre-processing operation, and the remote electronic device performs a post-processing operation.

In one embodiment, the distributed processing scenario module 450 can be used to save power during the wireless transmission between the wearable electronic device 100 and the remote electronic device 101/102. For example, the generated contextual information may indicate that the wireless transmission is associated with a large data amount, and the distributed processing scenario module 450 determines to control the wearable electronic device 100 to perform a pre-processing operation upon the raw sensor data to generate processed sensor data and transmit the processed sensor data to the remote electronic device 101 rather than transmitting raw sensor data if the raw sensor data have a relatively large data amount. The remote electronic device 101 is used to perform a post-processing operation upon the processed sensor data to complete the processing operation for the raw sensor data. For instance, instead of transmitting a full and uncompressed image stream (i.e. raw image data), the wearable electronic device 100 transmits detected object information (e.g. a flag indicating a person was detected) and/or motion vector information (e.g. data indicating a car moved from left to right) into the remote electronic device 101, to minimize data transmission bandwidth and processing load.

FIG. 6B is a diagram of an example of the distributed processing scenario according to an embodiment of the present invention. As shown in FIG. 6B, in one embodiment, the distributed processing scenario module 450, according to the contextual information, is used for distributing operation tasks between the wearable electronic device 100 and a remote electronic device such as a mobile phone 101 (or smartphone). After the camera (i.e., the sensor 105) captures raw images with 12-megapixel (12MP) configuration and transmits the raw images to the electronic device 110 of the wearable electronic device 100, the distributed processing scenario module 450 configures the electronic device 110 of the wearable electronic device 100 to perform only fundamental sensor compensation operations. These fundamental operations are configured to address artifacts generated based on the physical characteristics of the sensor 105, such as bad-pixel correction and crosstalk cancellation, and are executed during a pre-processing stage on the wearable electronic device 100. Subsequently, other types of image post-processing functions (e.g., complex ISP pipelines) are offloaded to the mobile phone 101. For example, the ISP sensor compensation is executed and completed on the wearable electronic device 100, and the ISP image processing functions are offloaded to the mobile phone 101. The mobile phone 101 processes and converts the received image data having 12MP configuration into the image data having 8-megapixel (8MP) configuration, i.e. 4K UHD (Ultra High Definition) resolution.

FIG. 6C is a diagram of an example of the distributed processing scenario according to an embodiment of the present invention. As shown in FIG. 6C, It should be noted that certain image processing methods, such as Electronic Image Stabilization (EIS) algorithms, require a significant amount of computational power to achieve stable and high-quality results. If the EIS is executed entirely by the wearable electronic device 100, the high computational demand results in excessive power consumption for the wearable electronic device 100. Conversely, if the EIS is executed entirely by the mobile phone 101, the wearable electronic device 100 is required to transmit a large volume of data (having 12MP configuration) to the mobile phone 101, which also consumes a relatively large amount of power due to transmission overhead. In one embodiment, the distributed processing scenario module 450 may employ a two-stage scheme to implement the EIS, wherein a first stage of the EIS is implemented on the wearable electronic device 100 (e.g., by the electronic device 110) and the wearable electronic device 100 processes and converts the large volume of data (having 12MP configuration) into a medium volume of data (having 10MP configuration) which is to be transmitted to the mobile phone 101, and a second stage of the EIS is implemented on the mobile phone 101 and the mobile phone 101 processes and converts the medium volume of data (having 10MP configuration) into data having 8MP configuration. This distribution achieves a balance between the stabilization effect and the computational power requirements.

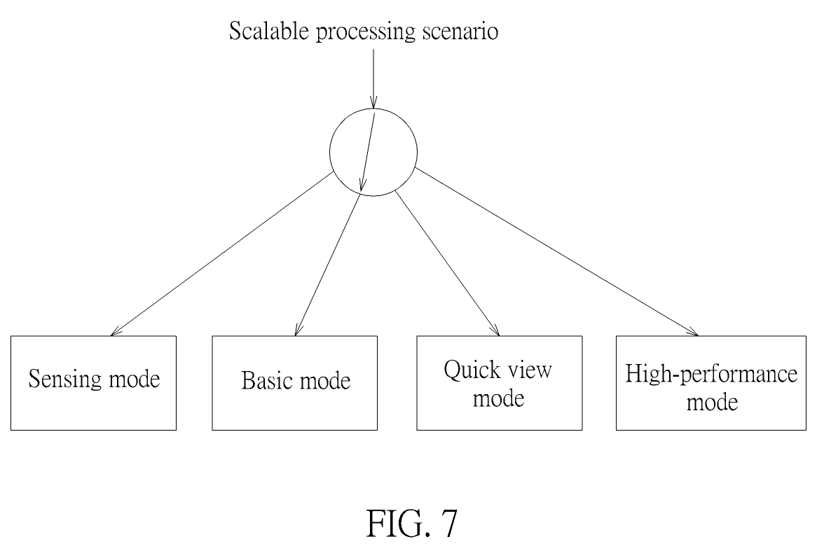

Furthermore, in another embodiment, the scalable processing scenario, according to the contextual information, is determined by the scalable processing scenario module 460 for adjusting operation mode or workload of the wearable electronic device 100. FIG. 7 is a diagram of an example of the scalable processing scenario according to an embodiment of the present invention. For example, the scalable processing scenario can be used to adjust the operation mode to balance image quality, latency, and/or power consumption. The wearable electronic device 100 can dynamically switch among multiple operation modes associated with different power consumption levels, latency budgets or output qualities, either alone or in combination thereof, according to the contextual information in the scalable processing scenario. The multiple operation modes for example (but not limited) include a sensing mode, a quick view mode, a basic mode, and a high-performance mode.

In the sensing mode, the wearable electronic device 100 for example is used to enable and control a first portion of units in the processing units such as image sensor 105, CPU 1105, GPU 1120, NPU 1115, VC 1160, and ISP 1110 to generate the image information with a limited quality (e.g. with a low frame rate or a low resolution) to minimize the power consumption. For example, functions of the image sensor 105, NPU 1115, and 3A control module 1150 are enabled and active in the sensing mode for performing simple motion detection upon the generated image frames, and the high detail is unnecessary in the sensing mode.

More specifically, in one embodiment, for the sensing mode, the image sensor such as 105 is configured to operate in a Monochrome (Mono) or Infrared (IR) mode to generate a sensed image with an output resolution which is set to a low resolution, e.g. 64x64 pixels, and with a low frame rate such as 3 frames per second (fps). The ISP 1110 is configured to control the 3A control module 1150 to perform a simple AE control upon the sensed image from the image sensor 105 to generate and ensure sufficient contrast. Unlike imaging pipelines, The ISP 1110 is configured to control the image data processed by the 3A control module 1150 to bypass the tone mapping module 1151, demosaic module 1152, and noise reduction module 1153, and is transmitted to the NPU 1115. The NPU 1115 is configured to analyze the processed image data to perform one or more environmental sensing tasks such as detecting user movement, identifying the presence of objects, or waking up other distinct circuits upon detecting specific triggers. This configuration minimizes power consumption by avoiding a high-resolution data readout and color processing.

In the quick view mode, the wearable electronic device 100 for example is used to enable and control a small portion (e.g. a second portion) of units in the processing units such as image sensor 105, CPU 1105, GPU 1120, NPU 1115, VC 1160, and ISP 1110 and generate small-size image information, and the second portion of units may be different from the first portion of units and consume power more than the first portion of units. For example, the wearable electronic device 100 may enable and configure the functions of image sensor 105, and ISP 1110 to produce thumbnail-sized images for preview purposes while the GPU 1120 and VC 1160 may be disabled.

Alternatively, in one embodiment for the quick view mode, for example, the quick view mode is used when the user requires an immediate, low-latency visual preview on a display of the wearable electronic device 100 such as a smart glass device, and in this mode the image sensor 105 is configured to operate in a Bayer RGB format which indicates the output resolution is for example increased to 640x480 pixels (VGA) with a frame rate of 15 fps. Then, the generated image data is transmitted to the ISP 1110 which can be configured to perform a low-quality or a light-weight processing upon the received image data. The processed image stream is then sent to the display of the wearable electronic device 100. This can avoid complex compression or storage operations as well as facilitate a real-time experience for the user.

In the basic mode, the wearable electronic device 100 for example is used to enable and control a large portion (e.g. a third portion) of units in the processing units such as image sensor 105, CPU 1105, GPU 1120, NPU 1115, VC 1160, and ISP 1110, and the third portion of units may be different from the second portion of units and consume power more than the second portion of units. For example, the image sensor 105, VC 1160, and ISP 1110 may be enabled and active to perform a basic image and video generating operation while the GPU 1120 is powered off to save energy.

More specifically, in one embodiment, for the basic mode, the image sensor 105 may operate in Bayer RGB format with a high resolution of 4000x3000 pixels (12 Megapixels) and a frame rate of 30 fps. Then, the high-resolution image data is processed by the ISP 1110 which is configured to perform a medium-quality processing upon the high-resolution image data. Specifically, the ISP 1110 applies a spatial domain noise reduction (e.g. enable the function of the noise reduction module 1153) to analyze pixels within a single frame to reduce noise. After the processing of ISP 1110, the processed image data is sent to the VC 1160 for compression (e.g., H.264 or H.265 encoding) and subsequently written to the local storage such as SLC cache 1130. The basic mode allows for a high-quality image capture.

In the high-performance mode, the wearable electronic device 100 for example is used to enable and control the full/all units in the processing units such as image sensor 105, CPU 1105, GPU 1120, NPU 1115, VC 1160, and ISP 1110 to generate sensed image information/frames with a relatively high quality. The full/all units in the processing units consume more power than the third portion of units.

More specifically, in one embodiment for the high-performance mode (or regarded as a full processing mode), the high-performance mode for example is utilized for achieving the highest image quality by leveraging the computational power of a remote electronic device such as a mobile phone. The image sensor 105 outputs the sensed images with Bayer RGB format at 4000x3000 pixels and 30 fps. The ISP 1110 performs a high-quality preliminary processing by specifically applying a temporal-domain noise reduction to analyze differences across multiple successive frames in the time domain to effectively remove noise particularly in low-light conditions. Additionally, the ISP 1110 may apply electronic image stabilization (EIS) operation to correct camera shake effects in the images. After the pre-processing of wearable electronic device 100, the processed data can be sent to the remote electronic device such as mobile phone 101 for the post-processing via the wireless communication of wireless communication module 1125. For example, the mobile device 101 receives the image stream and initiates a second stage of processing (i.e. post-processing) to perform an AI noise reduction by applying for example deep learning-based noise reducing algorithms, using the mobile device’s 101 graphics engine to perform a super resolution upscale operation to enhance the image resolution from the native 4000x3000 to a target resolution of approximately 6K. After the image enhancement operation is completed, the mobile device 101 uses its secondary codec circuit to compress the enhanced image stream and saves the compressed image content to its storage. Furthermore, the mobile device 101 may be configured to display the image content locally on its screen or transmit a corresponding video stream back to the wearable electronic device 100 to be viewed on the display of wearable electronic device 100, so as to provide the user with immediate feedback of the enhanced images.

By doing so, in the scalable processing scenario, the scalable processing scenario module 460 of wearable electronic device 100 can dynamically regulate the workload of the wearable electronic device 100 according to the contextual information currently generated. That is, the workload can be scalable, and this can effectively optimize the usage of battery power in response to different contextual information.

Further, in one embodiment, in the scalable processing scenario, the scalable processing scenario module 460 may dynamically adjust a module-configuration for a module of the wearable electronic device 100 to achieve one of the different power consumption levels, latency budgets or output qualities either alone or in combination thereof. This can achieve the tuning of one or more specific hardware modules. In this situation, the scalable processing scenario can be regarded as a module configuration scenario for the specific hardware module. For example, the scalable processing scenario module 460 can respectively adjust the configurations of specific hardware modules to achieve different power consumption levels.

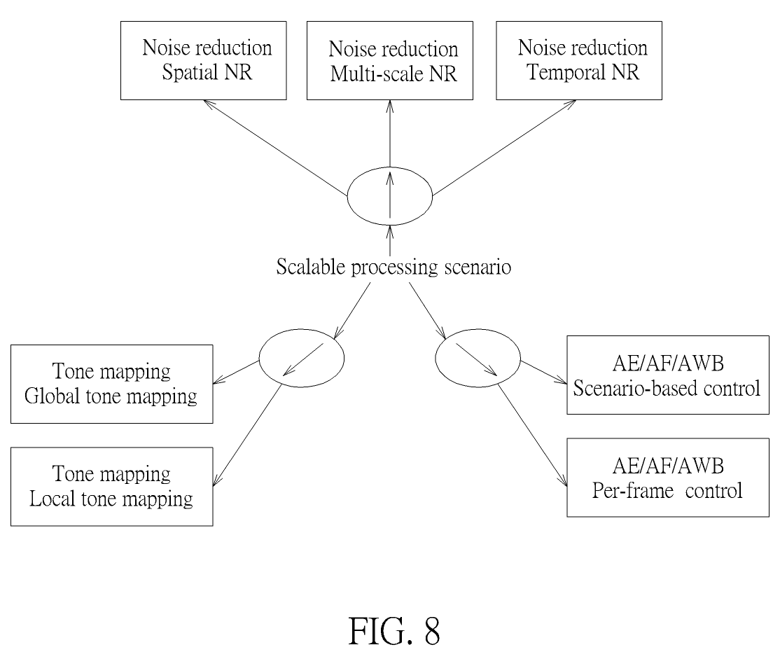

FIG. 8 is a diagram of an example of the scalable processing scenario for the module-configuration according to a different embodiment of the present invention. The module-configuration includes at least one of a noise reduction (NR) configuration, a tone mapping configuration, and a 3A control configuration. The NR configuration is used for configuring the noise reduction (NR) module 1153 to be operated among a spatial noise reduction mode, a multi-scale noise reduction mode, or a temporal noise reduction mode. In one embodiment, a hardware module such as a noise reduction (NR) hardware module 1153 of the ISP 1110 is configured to operate in different modes dynamically based on the different contextual information in the scalable processing scenario. For example, when the contextual information indicates that the battery power is low, the NR hardware module 1153 may perform a spatial NR operation based on a single image frame in response to the module-configuration of the spatial noise reduction mode and thus consume less power such as a first power level. When the contextual information indicates that the battery power is medium, the NR hardware module 1153 may perform a multi-scale NR operation based on consecutive image frames in response to the module-configuration of the multi-scale noise reduction mode and thus consume a second power level which greater than the first power level. When the contextual information indicates that the battery power is high, the NR hardware module 1153 may perform a temporal NR operation based on consecutive image frames in response to the module-configuration of the temporal noise reduction mode and thus consume a third power level which greater than the second power level. The temporal NR or multi-scale NR operations require to buffer the consecutive images in the memory module(s) and may require more processing power, and thus consume more energy to provide the better quality.

The tone mapping configuration is used for configuring the tone mapping module 1151 of ISP 1110 in FIG. 3 between a global tone mapping mode or a local tone mapping mode. The operation of global tone mapping mode is for example used to analyze the statistics of the entire sensed image (e.g. using a global histogram) to generate a single transfer curve which is applied to every single pixel regardless of whether a pixel is in a dark region or a bright region, and such operation can ensure the stability and lower power consumption for the computation. The operation of local tone mapping mode is for example used to analyze the statistics of a local neighborhood of a pixel to make a pixel in a dark region get a different brightening curve than a pixel in a bright region, so as to effectively make the human eye adapt to different brightness levels simultaneously, and such operation ensures the high dynamic range and local contrast. In one embodiment, the scalable processing scenario module 460 may dynamically adjust a tone configuration mode of the tone mapping module 1151 to switch between the global tone mapping mode (with less complexity and lower power) and the local tone mapping mode (with more complexity and higher power) in response to the different contextual information. For example, when the contextual information indicates that the battery power is low, the tone mapping module 1151 is configured to operate under the global tone mapping mode in response to the contextual information in the scalable processing scenario, to perform a tone mapping operation as well as save power. When the contextual information indicates that the battery power is high, the tone mapping module 1151 is configured to operate under the local tone mapping mode in response to the contextual information in the scalable processing scenario, to perform the tone mapping operation as well as achieve high performance.

In addition, the 3A control configuration is used for configuring the 3A control module 1150 of ISP 1110 in FIG. 3 between a scenario-based image processing or a per-frame control image processing. For example, the 3A control configuration is used for 3A control (i.e. the control of AE (auto exposure), AF (auto focus), and AWB (auto white balance)), and the 3A control module 1150 is configured to be switch between the scenario-based image processing and the per-frame control image processing according to the contextual information dynamically generated. The scenario-based image processing for example is the processing of a static scenario-based setting of 3A control for the 3A control module 1150 with less power consumption. The per-frame control image processing for example is used to adjust parameters of the 3A control module 1150 for every single frame of 3A control with consuming more power than applying the static scenario-based setting. Thus, similarly, when the contextual information indicates that the battery power is low, the scalable processing scenario module 460 can be used to configure the 3A control module 1150 to operate based on the configuration of the scenario-based image processing. Instead, when the contextual information indicates that the battery power is not low, the scalable processing scenario module 460 configures the 3A control module 1150 to operate based on the configuration of the per-frame control image processing.

Further, in one embodiment, the dynamic OS adjustment scenario, according to the contextual information, is determined and used by the dynamic operating system (OS)/service adjustment scenario module 470 for selecting an executed operating system among a plurality of OSs to be executed by the wearable electronic device 100. In this embodiment, the wearable electronic device 100 includes multiple operating systems, and can automatically switch between the operating systems dynamically according to the contextual information.

Furthermore, the dynamic operating system (OS)/service adjustment scenario module 470 can determine the module-configuration based on a target latency budget. The target latency budget indicates a maximum allowable delay for processing a data frame. For example, when the contextual information indicates a time-critical scenario (e.g., fast user movement), the dynamic operating system (OS)/service adjustment scenario module 470 sets the target latency budget to a low value (e.g., less than 16ms). To satisfy the target latency budget, the dynamic operating system (OS)/service adjustment scenario module 470 adjusts the module-configuration to select a low-latency processing mode. For instance, the dynamic operating system (OS)/service adjustment scenario module 470 configures the noise reduction module 1153 to switch from the temporal noise reduction mode to the spatial noise reduction mode. In this embodiment, the dynamic operating system (OS)/service adjustment scenario module 470 prioritizes the target latency budget over the power consumption levels to ensure real-time processing. Through this mechanism, the present invention effectively balances power, latency, and output quality by dynamically prioritizing the critical constraint (e.g., latency) identified from the contextual information.

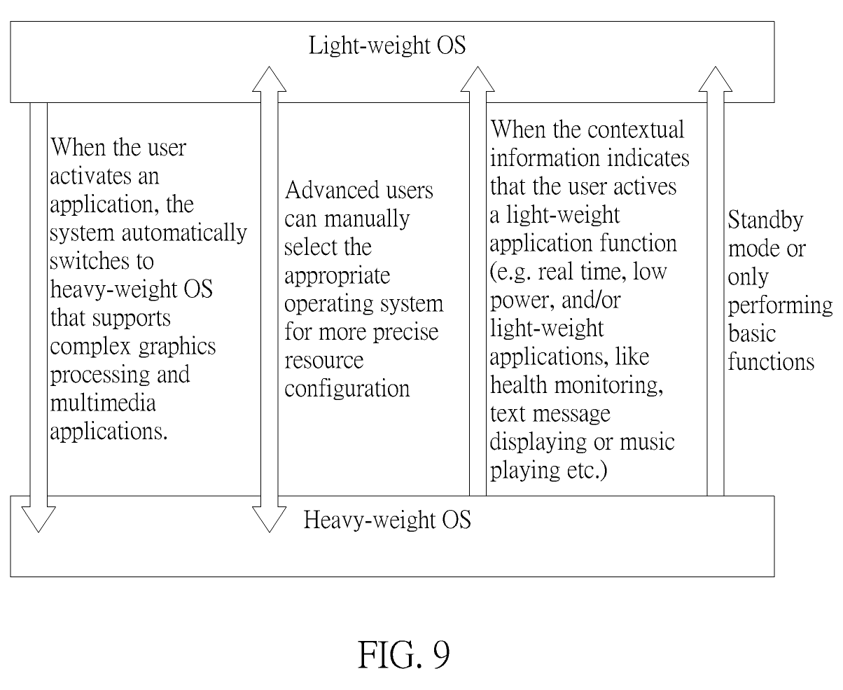

FIG. 9 is a diagram illustrating an example of the dynamic OS/service adjustment scenario according to a different embodiment of the present invention. In FIG. 9, for example, when the contextual information indicates a standby mode or indicates that a basic function execution (e.g. displaying time, receiving notifications) is performed, the dynamic operating system (OS)/service adjustment scenario module 470 of the wearable electronic device 100 switches to or maintains operating in the light-weight OS. When the contextual information indicates that the user activates an application (which requires complex operations), the dynamic operating system (OS)/service adjustment scenario module 470 of the wearable electronic device 100 switches from the light-weight OS to the heavy-weight OS which can support complex graphics processing and multimedia applications. When the contextual information indicates that the user activates a light-weight application function (e.g. real time, low power, and/or light-weight applications, like health monitoring, text message displaying or music playing etc.), the dynamic operating system (OS)/service adjustment scenario module 470 of the wearable electronic device 100 automatically switches from the heavy-weight OS to the light-weight OS such as the real-time operating system to provide accurate and rapid updates.

In further detail, the first OS and the second OS are configured with distinct processing characteristics to optimize system efficiency. The first OS (e.g., the light-weight OS) may be characterized as a real-time operating system (RTOS) or a system having a micro-kernel architecture capable of deterministic response and low-latency processing. The second OS (e.g., the heavy-weight OS) may be characterized as a general-purpose operating system (GPOS) or a system having a macro-kernel architecture providing a rich execution environment (REE) for high-throughput tasks.

Accordingly, in the dynamic OS adjustment scenario, the request for real-time response or low-latency processing corresponds to scenarios such as the text message displaying function or continuous health monitoring or walking tracking. In these scenarios, the wearable electronic device 100 utilizes the first OS to process continuous sensor data (e.g., GPS coordinates, accelerometer data) with minimal delay, ensuring timely turn-by-turn guidance without the power overhead of the second OS. Conversely, the request for high-performance computing or rich user interface interaction corresponds to application activations requiring complex rendering (e.g., video playback, 3D gaming), where the wearable electronic device 100 activates the second OS to utilize its superior graphics processing capabilities.

In addition, in one embodiment, the dynamic operating system (OS)/service adjustment scenario module 470 may also control the wearable electronic device 100 to select the executed OS according to the user’s user selection signal, to allow that the advanced users can manually select the appropriate operating system (e.g. heavy-weight OS or light-weight OS) for more precise resource configurations.

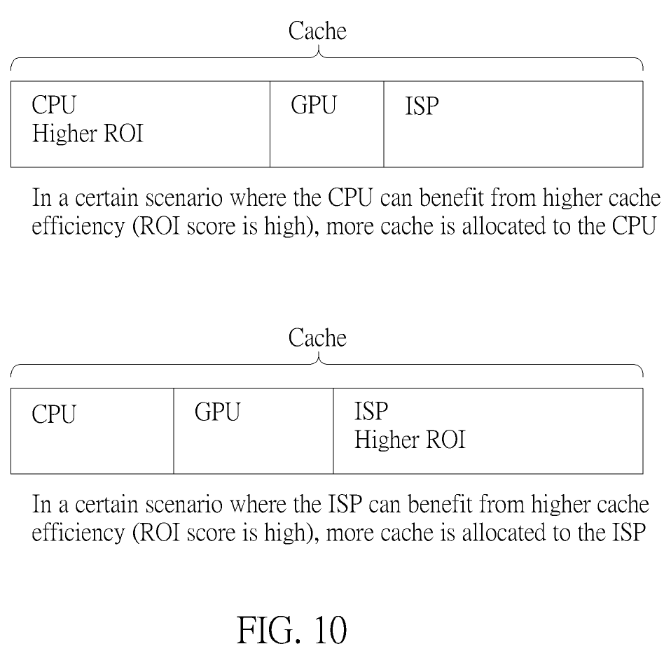

Further, the dynamic processing resources adjustment scenario, according to the contextual information, is determined and used by the dynamic processing resources adjustment scenario module 480 for dynamically allocating hardware resources such as a cache of the wearable electronic device 100. FIG. 10 is a diagram of an example of the dynamic processing resources adjustment scenario according to an embodiment of the present invention. In FIG. 10, for example, the dynamic processing resources adjustment scenario includes the decision unit’s 400 operations for performing a dynamic shared resource allocation operation by monitoring performance indicators of the plurality of modules(e.g. the hardware modules in FIG. 2 and FIG. 3) within the wearable electronic device 100, calculating return-on-investment (ROI) indicators respectively for the plurality of modules according to the performance indicators, and prioritizing the allocation of shared resource to the plurality of modules based on the return-on-investment indicators.

For example, in one embodiment, the dynamic processing resources adjustment scenario module 480 manages shared hardware resources such as a system level cache (SLC) by using the ROI metric. For example, for the ROI metric calculation, the ambient-adaptive sub-unit 405 fetches the performance indicators (e.g. throughput, latency, power consumption) of various hardware modules (e.g. CPU 1105, GPU 1120, ISP 1110) of the wearable electronic device 100 and send it to the context-aware sub-unit 410 for calculating an ROI indicator for each hardware module based on the corresponding fetched performance indicator. For example (but not limited), the ROI indicator of ISP 1110 is calculated by dividing the usage bandwidth of DRAM module 1135, requested by the ISP 1110, with the cache size of SLC 1130. For another example (but not limited), the ROI indicator of the CPU 1105 can be calculated by dividing the cache hit rate with the cache size of SLC 1130. The examples are not meant to be limitations of the present invention. Then, based on the calculated ROI indicators (or regarded as ROI scores), the dynamic processing resources adjustment scenario module 480 can dynamically configure and modify the SLC cache’s resource allocation for various processing units. For instance, as shown in FIG. 10, if the CPU 1105 has a higher ROI indicator/score in a scenario in which the CPU 1105 benefits from a higher cache efficiency, then the dynamic processing resources adjustment scenario module 480 configures the SLC cache 1130 to allocate more cache space to the CPU 1105 and to allocate less cache space to the GPU 1120 or ISP 1110. In another embodiment, if the ISP 1110 has a higher ROI indicator/score in a scenario in which the ISP 1110 benefits from a higher cache efficiency, then the dynamic processing resources adjustment scenario module 480 configures the SLC cache 1130 to allocate more cache space to the ISP 1110 and to allocate less cache space to the GPU 1120 or CPU 1105. This dynamic processing resources adjustment scenario can maximize the system performance and resource utilization of wearable electronic device 100.

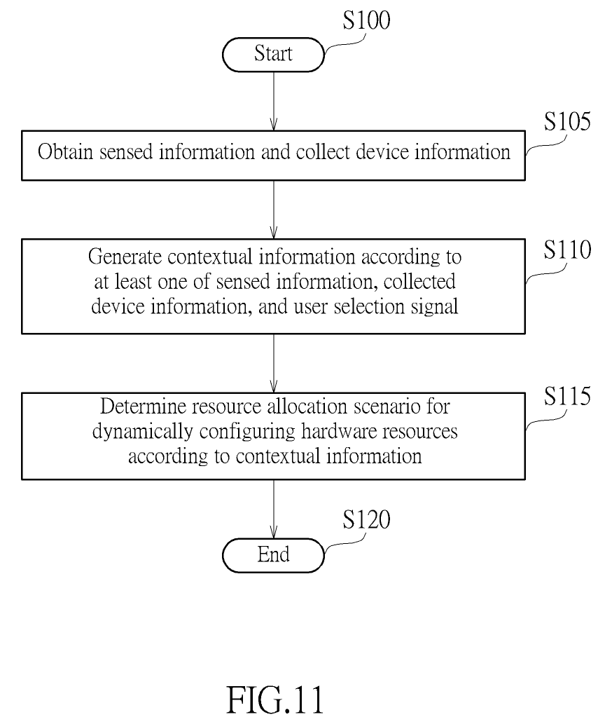

To make readers more clearly understand the spirits of the invention, FIG. 11 is provided. FIG. 11 is a diagram illustrating a method of the dynamic resource configuration operations for operating the wearable electronic device 100 as shown in FIG. 1 according to an embodiment of the invention. The steps of the method are described in the following:

Step S100: Start;

Step S105: Obtain sensed information from at least one sensor 105 of the wearable electronic device 100 and collect device information from the wearable electronic device 100;

Step S110: Generate contextual information according to at least one of the sensed information, the collected device information, and a user selection signal;

Step S115: Determine a resource allocation scenario for dynamically configuring hardware resources of the wearable electronic device 100 according to the contextual information; and

Step S120: End.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A dynamic resource configuration method of a wearable electronic device, comprising:
obtaining sensed information from at least one sensor of the wearable electronic device and collecting device information from the wearable electronic device;
generating contextual information according to at least one of the sensed information, the collected device information, and a user selection signal; and
determining a resource allocation scenario for dynamically configuring hardware resources of the wearable electronic device according to the contextual information.

2. The method of claim 1, wherein the dynamic resource configuration is performed in a closed-loop manner, and the method further comprises:
obtaining the device information indicating a performance status of the wearable electronic device; and
updating the resource allocation scenario based on the device information.

3. The method of claim 2, wherein the performance status comprises at least one of power consumption, latency, temperature, and a quality indicator.

4. The method of claim 1, wherein the sensed information comprises a light intensity, an ambient temperature, or a user movement status, and the device information comprises a battery status of a battery of the wearable electronic device, a charge/discharge status of the battery, a battery life, a history log, a processing power, a device temperature profile, a processor utilization, an available memory capacity, a cache occupancy, a memory bandwidth or an available resource.

5. The method of claim 1, wherein the generated contextual information comprises at least one of user information, a presence of a face or an object, user emotional information, image content information, image background information, environment information, and user social context information.

6. The method of claim 1, wherein the resource allocation scenario comprises at least one of:
a distributed processing scenario, according to the contextual information, for distributing operation tasks between the wearable electronic device and a remote electronic device;
a scalable processing scenario, according to the contextual information, for adjusting operation mode or workload of the wearable electronic device;
a dynamic operating system (OS)/service adjustment scenario, according to the contextual information, for selecting an executed operating system among a plurality of OSs to be executed by the wearable electronic device; and
a dynamic processing resources adjustment scenario, according to the contextual information, for dynamically allocating hardware resources of the wearable electronic device.

7. The method of claim 6, wherein the scalable processing scenario comprises dynamically switching the wearable electronic device among multiple operation modes associated with different power consumption levels, latency budgets or output qualities either alone or in combination thereof; or dynamically adjusting a module-configuration for a module of the wearable electronic device to achieve one of the different power consumption levels, latency budgets or output qualities either alone or in combination thereof.

8. The method of claim 7, wherein the multiple operation modes comprise at least one of:
a sensing mode for configuring the wearable electronic device to operate to generate the sensed information with limited quality to minimize power consumption;
a quick view mode for configuring the wearable electronic device to enable a small portion of processing units of the wearable electronic device to generate a small-size sensed information;
a basic mode for configuring the wearable electronic device to enable a large portion of processing units of the wearable electronic device to generate the sensed information with general quality; and
a high-performance mode for configuring the wearable electronic device to enable all the processing units of the wearable electronic device to generate the sensed information with relatively high quality.

9. The method of claim 7, wherein the module-configuration comprises at least one of:
a noise reduction configuration for configuring a noise reduction module to be operated among a spatial noise reduction mode, a multi-scale noise reduction mode, or a temporal noise reduction mode;
a tone mapping configuration for configuring a tone mapping module between a global tone mapping mode or a local tone mapping mode; and
a 3A control configuration for configuring a 3A control module between a scenario-based image processing or a per-frame control image processing.

10. The method of claim 6, wherein the dynamic operating system (OS)/service adjustment scenario further selects the executed operating system according to a user selection signal.

11. The method of claim 6, wherein the plurality of OSs comprise a first OS and a second OS associating with different power consumption levels; and the dynamic operating system (OS)/service adjustment scenario comprises performing the following steps:
switching to execute the second OS when the contextual information indicates a request for high-performance computing or rich user interface interaction; and
switching to execute the first OS or maintaining to execute the first OS when the contextual information indicates a request for real-time response, low-latency processing, or basic status maintenance.

12. The method of claim 6, wherein the dynamic processing resources adjustment scenario further comprises performing the following steps:
performing a dynamic shared resource allocation operation by monitoring performance indicators of a plurality of modules within the wearable electronic device;
calculating return-on-investment indicators respectively for the plurality of modules according to the performance indicators; and
prioritizing the allocation of shared resource to the plurality of modules based on the return-on-investment indicators.

13. The method of claim 1, wherein the resource allocation scenario comprises:
a slave/master processing scenario, according to the contextual information, for dynamically switching the wearable electronic device to be a master device or a slave device, and switching a remote electronic device to be a slave device or a master device.

14. A wearable electronic device, comprising:
at least one sensor, for providing a sensed information;
a memory circuit; and
a processing unit, coupled to the memory circuit and the at least one sensor, the processing unit comprising:
an ambient-adaptive sub-unit for obtaining the sensed information and collecting device information from the wearable electronic device; and
a context-aware sub-unit for generating contextual information according to at least one of the sensed information, the collected device information, and a user selection signal, and determining a resource allocation scenario for dynamically configuring hardware resources of the wearable electronic device according to the contextual information.

15. The wearable electronic device of claim 14, wherein the dynamic resource configuration is performed in a closed-loop manner; the ambient-adaptive sub-unit further obtains the device information indicating a performance status of the wearable electronic device, and the context-aware sub-unit updates the resource allocation scenario based on the device information.

16. The wearable electronic device of claim 15, wherein the performance status comprises at least one of power consumption, latency, temperature, and a quality indicator.

17. The wearable electronic device of claim 14, wherein the sensed information comprises a light intensity, an ambient temperature, or a user movement status, and the device information comprises a battery status of a battery of the wearable electronic device, a charge/discharge status of the battery, a battery life, a history log, a processing power, a device temperature profile, a processor utilization, an available memory capacity, a cache occupancy, a memory bandwidth or an available resource.

18. The wearable electronic device of claim 14, wherein the generated contextual information comprises at least one of user information, a presence of a face or an object, user emotional information, image content information, image background information, environment information, and a user’s social context information.

19. The wearable electronic device of claim 14, wherein the resource allocation scenario comprises at least one of:
a distributed processing scenario, according to the contextual information, for distributing operation tasks between the wearable electronic device and a remote electronic device;
a scalable processing scenario, according to the contextual information, for adjusting operation mode or workload of the wearable electronic device;
a dynamic operating system (OS)/service adjustment scenario, according to the contextual information, for selecting an executed operating system among a plurality of OSs to be executed by the wearable electronic device; and
a dynamic processing resources adjustment scenario, according to the contextual information, for dynamically allocating hardware resources of the wearable electronic device.

20. The wearable electronic device of claim 19, wherein the scalable processing scenario comprises the processing unit dynamically switching the wearable electronic device among multiple operation modes associated with different power consumption levels, latency budgets or qualities either alone or in combination thereof; or the processing unit dynamically adjusting a module-configuration for a module of the wearable electronic device to achieve one of the different power consumption levels, latency budgets or qualities either alone or in combination thereof.

21. The wearable electronic device of claim 20, wherein the multiple operation modes comprise at least one of:
a sensing mode for configuring the wearable electronic device to operate to generate the sensed information with limited quality to minimize power consumption;
a quick view mode for configuring the wearable electronic device to enable a small portion of processing units of the wearable electronic device to generate a small-size sensed information;
a basic mode for configuring the wearable electronic device to enable a large portion of processing units of the wearable electronic device to generate the sensed information with general quality; and
a high-performance mode for configuring the wearable electronic device to enable all the processing units of the wearable electronic device to generate the sensed information with relatively high quality.

22. The wearable electronic device of claim 20, wherein the module-configuration comprises at least one of:
a noise reduction configuration for configuring a noise reduction module to be operated among a spatial noise reduction mode, a multi-scale noise reduction mode, or a temporal noise reduction mode;
a tone mapping configuration for configuring a tone mapping module between a global tone mapping mode or a local tone mapping mode; and
a 3A control configuration for configuring a 3A control module between a scenario-based image processing or a per-frame control image processing.

23. The wearable electronic device of claim 19, wherein the dynamic operating system (OS)/service adjustment scenario further selects the executed operating system according to an user selection signal.

24. The wearable electronic device of claim 19, wherein the plurality of OSs comprise a first OS and a second OS associating with different power consumption levels; and the dynamic operating system (OS)/service adjustment scenario comprises the processing unit performing the following steps:
switching to execute the second OS when the contextual information indicates a request for high-performance computing or rich user interface interaction; and
switching to execute the first OS or maintaining to execute the first OS when the contextual information indicates a request for real-time response, low-latency processing, or basic status maintenance.

25. The wearable electronic device of claim 19, wherein the dynamic processing resources adjustment scenario further comprises performing the following steps:
performing a dynamic shared resource allocation operation by monitoring performance indicators of a plurality of modules within the wearable electronic device;
calculating return-on-investment indicators respectively for the plurality of modules according to the performance indicators; and
prioritizing the allocation of shared resource to the plurality of modules based on the return-on-investment indicators.

26. The method of claim 14, wherein the resource allocation scenario comprises:
a slave/master processing scenario, according to the contextual information, for dynamically switching the wearable electronic device to be a master device or a slave device, and switching a remote electronic device to be a slave device or a master device.
